(19) United States
(12) Patent Application Publication
(10) Pub. No.: US 2026/0094864 A1
(43) Pub. Date: Apr. 2, 2026

(54) SLURRY FOR OXIDE-BASED SOLID ELECTROLYTE AND OXIDE-BASED SOLID ELECTROLYTE SHEET

(71) Applicant: SK ON CO., LTD., Seoul (KR)

(72) Inventors: Ji Young PARK, Daejeon (KR); Myung Soo PARK, Daejeon (KR); Kyeong Joon KIM, Daejeon (KR)

(21) Appl. No.: 19/340,884

(22) Filed: Sep. 26, 2025

(30) Foreign Application Priority Data
Oct. 2, 2024 (KR) 10-2024-0134021

(51) Int. Cl. H01M 10/056; H01M 10/052

(52) U.S. Cl. CPC H01M 10/056; H01M 10/052; H01M 2300/0077; H01M 2300/0082

(57) ABSTRACT

A slurry for an oxide-based solid electrolyte according to an embodiment includes a conductive polymer and oxide particles. According to an embodiment, an oxide-based solid electrolyte sheet may be manufactured from the slurry for an oxide-based solid electrolyte. According to an embodiment, the electronic conductivity of the slurry for an oxide-based solid electrolyte may be increased to increase a photothermal conversion rate and significantly improve thermal conductivity, thereby enhancing the efficiency of photo-sintering. According to another embodiment, a sheet having a homogeneous surface may be obtained. According to another embodiment, a secondary battery having improved safety and energy density may be obtained.

### CROSS-REFERENCE TO RELATED APPLICATION(S)

This patent document claims the priority and benefits of Korean Patent Application No. 10-2024-0134021 filed on Oct. 2, 2024, the disclosure of which is incorporated herein by reference in its entirety.

### TECHNICAL FIELD

The disclosure and implementations disclosed in this patent document generally relate to a slurry for an oxide-based solid electrolyte and an oxide-based solid electrolyte sheet.

### BACKGROUND

With growing interest in environmental issues, research is actively underway into electric vehicles (EV) that can replace fossil fuel-powered vehicles, a major source of air pollution, and energy storage systems (ESS) that utilize renewable energy. Lithium secondary batteries, which boast high discharge voltage and stable output, are primarily used as power sources for such EVs.

Meanwhile, conventional lithium secondary batteries to which liquid electrolytes such as organic solvents are applied, may have a risk of fire due to electrolyte leakage, and electrode reactions may cause electrolyte decomposition, leading to battery expansion. Furthermore, existing lithium secondary batteries, including separators, limit their ability to achieve high energy densities.

Consequently, in order to address the limitations and issues associated with a secondary battery including an electrolyte, research and development are actively underway on all-solid-state lithium secondary batteries using solid-state electrolytes, and thereamong, research is currently underway on all-solid-state e lithium secondary batteries using oxide-based solid electrolytes.

### SUMMARY

According to an aspect of the present disclosure, lithium volatilization from an oxide may be prevented and the density of an oxide-based solid electrolyte sheet may be easily controlled.

According to another aspect of the present disclosure, the processability of an oxide-based solid electrolyte sheet may be improved and a surface of a sheet may be formed uniformly.

According to another aspect of the present disclosure, photothermal conversion efficiency and thermal conductivity may be increased, thereby improving photo-sintering efficiency.

A slurry for an oxide-based solid electrolyte according to the present disclosure may include a conductive polymer and oxide particles.

According to an embodiment, the conductive polymer may include a π-conjugated polymer structure.

According to an embodiment, the conductive polymer including a π-conjugated polymer structure may be one of polyacetylene (PA) and poly(p-phenylene vinylene) (PPV), or a mixture thereof.

According to an embodiment, the conductive polymer may further include a heteroatom in a polymer main chain.

According to an embodiment, the conductive polymer further including a heteroatom in the polymer main chain may be one of polypyrrole (PPy), polythiophene (PT), poly(3,4-ethylene dioxythiophene (PEDOT)), poly(p-phenylene vinylene) (PPV) and polyaniline (PANi), or a mixture thereof.

According to an embodiment, the conductive polymer may further include a doped heteroatom.

According to an embodiment, the conductive polymer may have a weight average molecular weight of 5,000 to 200,000 g/mol.

According to an embodiment, the conductive polymer may have a particle size of 3 to 100 μm.

According to an embodiment, the conductive polymer may have an electrical conductivity of 1 S/cm or more.

According to an embodiment, the slurry for an oxide-based solid electrolyte may further include a non-conductive binder.

According to an embodiment, the conductive polymer may include a binding block.

According to an embodiment, the binding block may be a chain-like alkyl ether having 1 to 5 carbon atoms or an alkyl ester having 1 to 8 carbon atoms.

According to an embodiment, the conductive polymer including the alkyl ether binding block having 1 to 5 carbon atoms may be at least one selected from the group consisting of poly(ethylene oxide), poly(propylene oxide) and polytetrahydrofuran.

According to an embodiment, the conductive polymer including the alkyl ester binding block having 1 to 8 carbon atoms may be at least one selected from the group consisting of polycaprolactone, polylactide, polybutylene adipate and poly(methyl methacrylate).

According to an embodiment, the conductive polymer including the binding block may be at least one selected from the group consisting of PEDOT-block-PEG and polypyrrole-block-poly(caprolactone).

According to an embodiment, the conductive polymer may be included in an amount of 3 to 15 wt % based on a total weight of the slurry for an oxide-based solid electrolyte.

An oxide-based thin film sheet according to the present disclosure may include a substrate and an oxide-based thin film layer formed of the slurry for an oxide-based solid electrolyte on the substrate.

In another embodiment, the oxide-based thin film sheet may have a sheet resistance of 100 MΩ/sq or less.

In another embodiment, the oxide-based thin film sheet may have a colorimetric value of 60 or less.

In another embodiment, the conductive polymer may be included in an amount of 5 to 50 wt % based on a total weight of a solid content.

According to an embodiment of the present disclosure, the electronic conductivity of a slurry for an oxide-based solid electrolyte may be increased to increase a photothermal conversion rate and significantly improve thermal conductivity, thereby enhancing the efficiency of photo-sintering.

According to another embodiment of the present disclosure, the colored properties of a conductive polymer may be utilized to enhance light absorption, thereby improving the efficiency of photo-sintering.

According to another embodiment of the present disclosure, a sheet with a homogeneous surface may be obtained.

According to another embodiment of the present disclosure, a secondary battery with improved safety and energy density may be obtained.

### BRIEF DESCRIPTION OF DRAWINGS

Certain aspects, features, and advantages of the present disclosure are illustrated by the following detailed description with reference to the accompanying drawings.

FIG. 1 is a photograph obtained by capturing an oxide-based solid electrolyte slurry according to Examples 1 and 2 and Comparative Example 1.

FIG. 2 is a photograph of casting an oxide-based solid electrolyte slurry according to Examples 1 and 2 and Comparative Example 1 onto a substrate.

FIG. 3 is a photograph obtained by capturing an oxide-based thin film sheet produced by casting an oxide-based solid electrolyte slurry according to Examples 1 and 2 and Comparative Example 1 onto a substrate and then drying the same.

FIG. 4 illustrates a microstructure of oxide-based thin film sheets according to Examples 1 and 2 and Comparative Example 1 before photo-sintering.

FIG. 5 illustrates a microstructure of oxide-based thin film sheets according to Examples 1 and 2 and Comparative Example 1 after photo-sintering.

### DETAILED DESCRIPTION

Hereinafter, the present disclosure will be described in detail. However, this is merely exemplary and the present disclosure is not limited to the specific embodiments described as examples.

In the present disclosure, “sintering” refers to a phenomenon in which powder particles adhere tightly to each other and solidify due to heat, and refers to a process in which the powder particles adhere to each other and become a single mass through a thermal activation process.

A solid electrolyte to which an all-solid-state lithium secondary battery is applied is primarily classified into a sulfide-based electrolyte, a polymer-based electrolyte, and an oxide-based electrolyte, and thereamong, the oxide-based solid electrolyte is attracting attention as next-generation solid electrolyte materials due to superior chemical/thermal stability and mechanical strength. Conventionally, oxide-based solid electrolytes are formed by forming a slurry including oxide particles and a binder into a predetermined shape, and then sintering the slurry at high temperatures, such as 1,000° C. or higher, for an extended period of time, such as one hour. During the thermal sintering process, components such as lithium included in the oxide particles may volatilize, resulting in material loss. Furthermore, density control may be difficult depending on sintering conditions, and a substrate may become deformed or destroyed as an entire substate is heated. When manufacturing an oxide sheet through a thermal sintering process, since it is difficult to thin the sheet and form a uniform surface, additional processing may be required.

The present disclosure relates to a method of performing sintering using light in the manufacturing of an oxide-based solid electrolyte, and sintering using the light is hereinafter referred to as “light sintering.” More specifically, “light sintering” refers to a process in which a momentary light pulse is applied to induce a resonance phenomenon between the material's inherent wavelength range and the light's wavelength range, and heat generation therefrom to generate a thermal reaction within the material and sinter the material, and thus, such a process allows for the manufacturing of a sintered body without the problems associated with thermal sintering described above.

For example, when manufacturing a sintered body using light sintering, this may be applied to large-area substrates, independently of a sheet shape according to a size of a base material and a light source, and a slurry printed on the substrate may be sintered in a very short time under room temperature and atmospheric pressure, facilitating mass production.

Furthermore, light sintering involves applying optical energy for a very short time, and thus allows for the formation of particle-to-particle connections in a shorter time as compared to thermal sintering. Furthermore, manufacturing a sintered body using light sintering may eliminate the problem in which a substrate is heated, and may allow for selective sintering of an oxide-based thin film sheet.

The light sintering described above may be performed by applying an oxide-based solid electrolyte slurry including oxide particles onto a predetermined substrate, producing a molded body having a predetermined shape, and then irradiating the molded body with optical energy.

The oxide-based solid electrolyte slurry is intended for manufacturing an oxide-based solid electrolyte sheet and includes oxide particles and a conductive polymer.

The oxide particles may include at least one selected from zirconium (Zr), phosphate (PO₄) and titanium (Ti). Specifically, the oxide particles may be one or more compounds selected from a lithium lanthanum zirconium oxide (LLZO) compound, a lithium lanthanum titanate oxide (LLTO) compound, a lithium aluminum germanium phosphate (LAGP) compound, or a lithium aluminum titanium phosphate (LATP) compound. More specifically, the lithium conductive oxide particles may be a lithium lanthanum zirconium oxide (LLZO) compound represented by a chemical formula, Li₇La₃Zr₂O₁₂, and having a garnet structure.

A content of the oxide particles in the slurry for an oxide-based solid electrolyte may range from 15 to 64 wt %. When the content of the oxide-based particles included in the slurry for an oxide-based solid electrolyte is 15% by weight or more, the density and strength of the oxide film may be sufficiently secured, and when the content thereof is 64 wt % or less, a uniform film may be formed.

The conductive polymer may function as a binder for the oxide-based solid electrolyte slurry. Accordingly, the conductive polymer may bind the oxide particles and may enhance the adhesion of the oxide-based solid electrolyte slurry to the substrate.

Furthermore, the conductive polymer provides electronic conductivity during a photo-sintering process, thereby enhancing the photo-sintering effect. More specifically, when a molded body manufactured using the oxide-based solid electrolyte slurry including the conductive polymer is photo-sintered, the high electronic conductivity of the conductive polymer may increase a photothermal conversion rate and may significantly enhance thermal conductivity, thereby enhancing the efficiency of the photo-sintering process. Furthermore, since the conductive polymer is colored, the slurry for an oxide-based solid electrolyte may be provided to have a color, thereby enhancing light absorption during photo-sintering and improving photo-sintering efficiency.

The conductive polymer may include a n-conjugated polymer structure. The n-conjugated polymer structure of the conductive polymer means that electrons are delocalized throughout a polymer main chain via successive sp2 hybrid orbitals. Such electron delocalization allows the conductive polymer to exhibit electrical conductivity. Examples of conductive polymers including the n-conjugated polymer structure include, but are not limited to, polyacetylene (PA) and poly(p-phenylene vinylene) (PPV).

The conductive polymer may further include a heteroatom in the polymer main chain. The heteroatom may be at least one selected from N, O and S. When heteroatoms such as N, S and O are included in the polymer main chain, conductive polymers with a wider variety of structures may be designed. Unshared electron pairs of the heteroatoms may participate in the formation of successive sp2 hybrid orbitals, thereby forming a n-conjugated polymer structure.

The conductive polymer including additional heteroatoms include, but is not limited to, polypyrrole (PPy), polythiophene (PT), poly(3,4-ethylene dioxythiophene (PEDOT) and polyaniline (PANi). These may be represented by the following chemical formula 1:

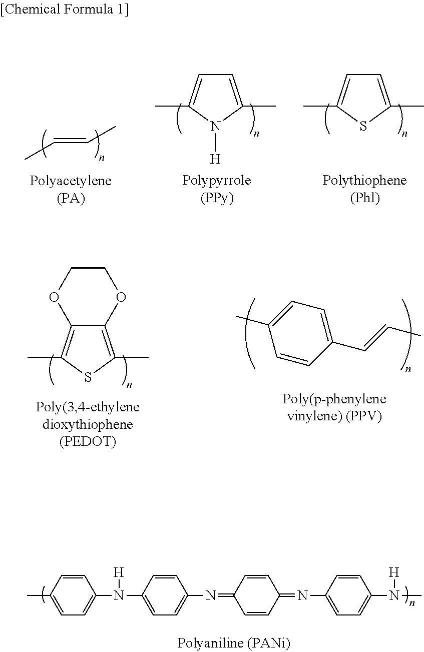

The conductive polymer described above may be any one of these, or a mixture of two or more. Specifically, the conductive polymer may be polyaniline, and the polyaniline is readily available and may be obtained in a dry solid state, thereby facilitating the manufacturing of a slurry for light sintering.

The heteroatom may also be doped into the conductive polymer. Doping may be achieved by oxidation or reduction of the conductive polymer. When anions are doped by oxidation of the conductive polymer, a hole is created in an electrical structure of the n-conjugated polymer, and electrons move from adjacent carbon to fill the created hole, thus creating another hole. Because such a conduction process is repeated, the doped conductive polymer exhibits higher electrical conductivity than the undoped polymer.

A case in which the conductive polymer may be doped with the heteroatom is not limited thereto, but for example, polyacetylene may be doped with iodine ions (I₃⁻), or poly(3,4-ethylenedioxythiophene) may be doped with polystyrene sulfonate (PSS).

The conductive polymer may have a weight-average molecular weight of, but is not limited to, 5,000 to 200,000 g/mol. The weight-average molecular weight of the conductive polymer may be measured using gel permeation chromatography (GPC). In the case in which the weight-average molecular weight of the conductive polymer is 5,000 g/mol or more, when the slurry is prepared using the same, coated on a base material and dried, the coating layer may be prevented from peeling off the base material, and in the case in which the weight-average molecular weight exceeds 200,000 g/mol, the conductive polymer may be sufficiently dissolved in a solvent used in manufacturing the slurry. For example, the polyaniline may have a weight average molecular weight of 15,000 g/mol or more.

The conductive polymer may have a particle size of 3 to 100 μm. When the particle size of the conductive polymer exceeds 100 μm, it may be difficult to dissolve in a solvent.

Furthermore, the conductive polymer may have an electrical conductivity of 1 S/cm or more. When the electrical conductivity of the conductive polymer is 1 S/cm or more, the effect of increasing the efficiency of light sintering is even more remarkable.

The oxide-based solid electrolyte slurry may further include a non-conductive binder separate from the conductive polymer. When a conductive polymer having poor binding properties is used, the binding properties may be improved by adding the non-conductive binder.

The non-conductive binder binds to the oxide particles and contributes to improving the adhesion of the oxide-based solid electrolyte slurry to the substrate, and the non-conductive binder may be dissolved in the same solvent as the conductive polymer, and is not particularly limited as long as this is a binder that may be used for sintering at a photo-sintering temperature of 300° C. to 1000° C.

For example, polyvinyl butyral (PVB), polyvinyl alcohol (PVA), polyethylene, polyurethane, polyvinyl chloride, polyvinyl acetate, polyacrylic acid ester, polymethacrylic acid ester, polyalkylene oxide, cellulose dielectric, and polyvinylidene fluoride (PVdF) may be used as the non-conductive binder. Any one of these may be used alone, or two or more may be used in combination.

The conductive polymer may include a binding block. The fact that the conductive polymer includes a binding block indicates a copolymer in which the conductive polymer and the non-conductive binder polymer are copolymerized, and the conductive polymer block imparts electronic conductivity, and the binding block has the effect of improving binding properties.

The binding block may be a chain-like alkyl ether or an alkyl ester, and may specifically be an alkyl ether having 1 to 5 carbon atoms or an alkyl ester having 1 to 8 carbon atoms.

The present disclosure is not limited thereto, but the conductive polymer including the alkyl ether binding block may be, for example, poly(ethylene oxide), poly(propylene oxide), or polytetrahydrofuran. The present disclosure is not limited thereto, but the conductive polymer including the alkyl ester binding block may be, for example, polycaprolactone, polylactide, polybutylene adipate, or poly(methyl methacrylate).

Furthermore, the conductive polymer including the binding block may include, but is not limited to, may be at least one selected from the group consisting of PEDOT-block-PEG represented by Chemical Formula 2 below and polypyrrole-block-poly(caprolactone) represented by Chemical Formula 3 below.

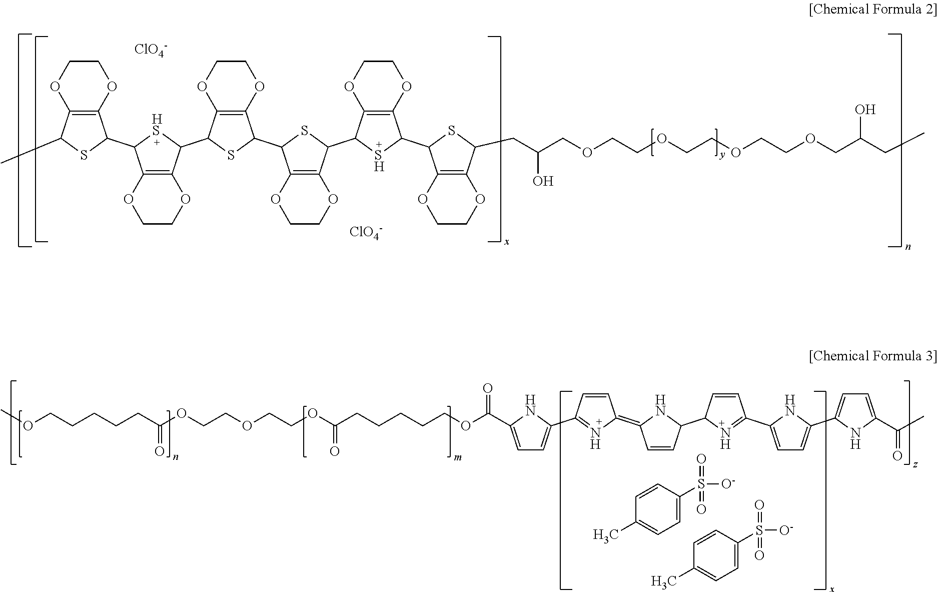

The conductive polymer may be included in an amount of 3 to 15 wt % based on the total weight of the slurry for the oxide-based solid electrolyte. When the content of the conductive polymer is 3 wt % or more, the physical properties of the slurry may be secured and a uniform thin film may be formed, and when the content of the conductive polymer is 15 wt % or less, the density and strength of the film may be improved.

The oxide-based solid electrolyte slurry may include a solvent. The solvent serves to dissolve the components within the oxide-based solid electrolyte slurry, and a polar solvent may be used as the solvent, and the solvent may be, but is not limited thereto, methylpyrrolidone (N-Methyl-2-pyrrolidone, NMP), methanol, ethanol, propanol, butanol, methyl ethyl ketone, methyl isobutyl ketone, toluene, and xylene.

The solvent may be included in an amount of 30 to 70 wt % based on the total weight of the oxide-based solid electrolyte slurry. When the content of the solvent is 30 wt % or more, the slurry may be uniformly mixed, and when the content of the solvent is 70 wt % or less, the slurry viscosity may sufficiently be secured to facilitate the formation of the sheet.

The slurry for an oxide-based solid electrolyte may include a dispersant. The dispersant serves to uniformly distribute oxide particles within the slurry for an oxide-based solid electrolyte, and may be an acrylic acid-based, fatty acid-based dispersant, a sulfonic acid-based dispersant, a phosphoric acid ester-based dispersant, a sulfuric acid ester-based dispersant, a polyalkylene glycol-based dispersant, or an amine-based dispersant, and may be included alone or in combination of two or more.

The dispersant may be included in an amount of less than 8 wt %. When the content of the dispersant is within the above-described range, the homogeneity of the obtained electrolyte sheet may be further improved.

The slurry for an oxide-based solid electrolyte may include a plasticizer. The plasticizer serves to control the viscosity of the oxide-based solid electrolyte slurry, and may be dibutyl phthalate (DBP) and fatty acid ester glycerin, which may be included alone or in combination.

The plasticizer may be included in an amount of less than 8 wt %. When the content of the plasticizer is within the above-described range, the plasticizer may increase the flexibility of the obtained electrolyte sheet and may control the viscosity of the slurry due to the binder.

The oxide-based solid electrolyte slurry may be cast onto a substrate and then dried to manufacture a molded body of an oxide-based thin film sheet. The oxide-based thin film sheet may include a substrate and an oxide-based thin film layer formed on the substrate using the oxide-based solid electrolyte slurry. A method of casting the slurry onto the substrate is not particularly limited, and may be applied using methods such as tape casting, bar coating, screen printing, or thermal spray coating.

A method for drying the oxide-based solid electrolyte slurry cast on the substrate is not particularly limited, and drying may be performed using a convection oven or the like. The drying may be performed at a temperature of 50 to 200° C., specifically, at a temperature of 80 to 120° C. Furthermore, the drying may be performed for 0.5 to 5 hours, specifically, for 1 to 3 hours.

The substrate onto which the oxide-based solid electrolyte slurry is cast is not particularly limited, and any substrate that does not transmit light may be used. For example, a current collector formed of copper (Cu) or aluminum (Al) may be used. Additionally, the substrate may be an anode or a cathode for a lithium secondary battery. Furthermore, the size of the substrate is not particularly limited, and various substrate sizes, including small-area substrates and large-area substrates, may be used. Furthermore, the substrate may have a thickness of 5 to 200 μm.

The oxide-based thin film sheet may have a thickness of 10 μm to 300 μm. When the oxide-based thin film sheet has a thickness within the above-described range, an oxide-based solid electrolyte sheet that is thinned to a thin thickness and has excellent durability, and the like, may be manufactured.

The oxide-based thin film sheet may have a sheet resistance of 100 MΩ/sq or less. When the sheet resistance of the oxide-based thin film sheet exceeds 100 MΩ/sq, conductivity may decrease, which may lead to a problem of reduced light sintering efficiency.

The oxide-based thin film sheet may have a colorimetric L value of 60 or less. When the oxide-based thin film sheet has a colorimetric L value exceeding 60, light reflection and scattering within the sheet significantly may increase, which may reduce light absorption and may significantly reduce light sintering efficiency.

The oxide-based thin film sheet may include the conductive polymer in an amount of 5 to 50 wt % based on the total solid content. When the content of the conductive polymer is 5 or more, slurry processability and photo-sintering efficiency may be significantly improved, and when the content thereof is 50 or less, sufficient density and strength of the oxide sheet may be secured.

The oxide-based thin film sheet formed on the substrate may be photo-sintered to manufacture an oxide-based solid electrolyte sheet.

The photo-sintering may be performed using a pulsed method. The pulsed method refers to a method in which a strong voltage is applied in pulses to a light-generating device, such as a lamp, to irradiate the device with intense light generated instantaneously, and the light energy supplied by the irradiation may generate heat, which may induce photo-sintering. In this case, the photo-sintering device that generates light using the pulsed method is not particularly limited as long as this may operate under the pulse conditions set below.

During the photo-sintering, the light irradiation time per pulse (on-time), operating voltage (V), number of pulses, a temperature-increasing frequency (fire rate, Hz) forming a total pulse, number of pulse repetitions, the photo-sintering operation time, and the like, may be appropriately varied (adjusted) by controlling the photo-sintering device's controller, power supply, and the like.

During the light sintering, the light irradiation time (on-time) per pulse may be 1000 to 4500 μs. Specifically, the light irradiation time (on-time) per pulse may be 1200 μs or more, or 1400 μs or more, and 4400 μs or less, 4200 μs or less, or 4000 μs or less.

The operating voltage during the light sintering may be 100 to 450 V. Specifically, the operating voltage may be 120 V or more, or 150 V or more, and 440 V or less, 430 V or less, or 420 V or less.

A duty cycle (%) during the light sintering may be 10 to 100%. Specifically, the duty cycle (%) may be 20 to 90%. The duty cycle may be calculated as a value of a ratio (%) of a light irradiation time per pulse (on-time) to the pulse cycle.

The number of pulse repetitions during the light sintering process may be 1 to 20. Specifically, the number of pulse repetitions during the light sintering process may be 5 to 15.

When the light irradiation time per pulse (on-time), an operating voltage, a duty cycle (%), and a cycle count during the light sintering process are controlled within the above-described range, the light sintering process time calculated by Equation 1 below may be shortened, thereby allowing a sintering process to proceed in a short period of time.

$${T}_{s} = C / {T}_{r} \qquad [ Equation 1 ]$$

In Equation 1, Tₛ is the photo-sintering operation time (s), Tᵣ is the temperature-increasing frequency (fire rate, Hz), and C is the number of pulse repetitions. The temperature-increasing frequency (fire rate, Hz) forming a total pulse during the photo-sintering may range from 1 to 50 Hz. Specifically, the temperature-increasing frequency (fire rate, Hz) forming the total pulse during the photo-sintering may be 10 or more and 40 Hz or less.

The number of pulse repetitions during the photo-sintering may range from 50 to 1,000. Specifically, the number of repetitions during the photo-sintering may be 50 or more and 400 or less. A temperature of the substrate during the photo-sintering may be maintained at 300° C. or less. Specifically, the temperature of the substrate during the photo-sintering process may be maintained at 5 to 100° C., 10 to 50° C., or 15 to 30° C. More specifically, the substrate temperature during the photo-sintering process may be maintained at room temperature (RT) of 20 to 25° C. When the temperature of the substrate is maintained within the above-described range during the photo-sintering process, thermal stress remaining on the substrate may be prevented, and thus, problems such as substrate destruction and reduced durability may be substantially mitigated, and a wide variety of substrates may be selected and applied to the photo-sintering process without limitation.

The light energy irradiated during the photo-sintering may be 25 to 150 J/s·cm². Specifically, the light energy irradiated during the photo-sintering may be 40 to 120 J/s·cm².

The oxide-based solid electrolyte sheet may have an area of 0.25 cm² or greater. Specifically, the oxide-based solid electrolyte sheet may have an area of 0.5 to 50 cm².

A width and a length of the oxide-based solid electrolyte sheet may each be 0.5 cm or more, and specifically, the width and the length of the oxide-based solid electrolyte sheet may each be 0.5 to 10 cm.

When the area, width, and length of the oxide-based solid electrolyte sheet are within the above-described range, the oxide-based solid electrolyte sheet may have a relatively large area and size as compared to oxide-based solid electrolytes manufactured using existing processes, thereby improving the productivity and economic feasibility of manufacturing the oxide-based solid electrolyte sheet.

The oxide-based solid electrolyte sheet may have a thickness of 10 to 300 μm. Specifically, the thickness of the oxide-based solid electrolyte sheet may be 30 μm or more, 200 μm or less, or 100 μm or less. When the thickness of the oxide-based solid electrolyte sheet falls within the above-described range, the oxide-based solid electrolyte sheet may have excellent ionic conductivity as a thin film, and may achieve higher energy density when applied to all-solid-state lithium secondary batteries.

The oxide-based solid electrolyte sheet may be manufactured by photo-sintering, so that a thin-film oxide electrolyte layer may have formed, and since photo-energy is irradiated locally only on a surface thereof, selective sintering may be possible.

Furthermore, photo-sintering may allow for the formation of a structure forming interparticle connection points identical to thermal sintering in a short period of time, within several seconds, and the oxide-based solid electrolyte sheet may be manufactured regardless of the shape of the sheet, depending on the size of a light source.

### EXAMPLE

The following examples are described in detail. The following examples are provided solely for the purpose of understanding the present disclosure and are not intended to limit the present disclosure.

### Example 1

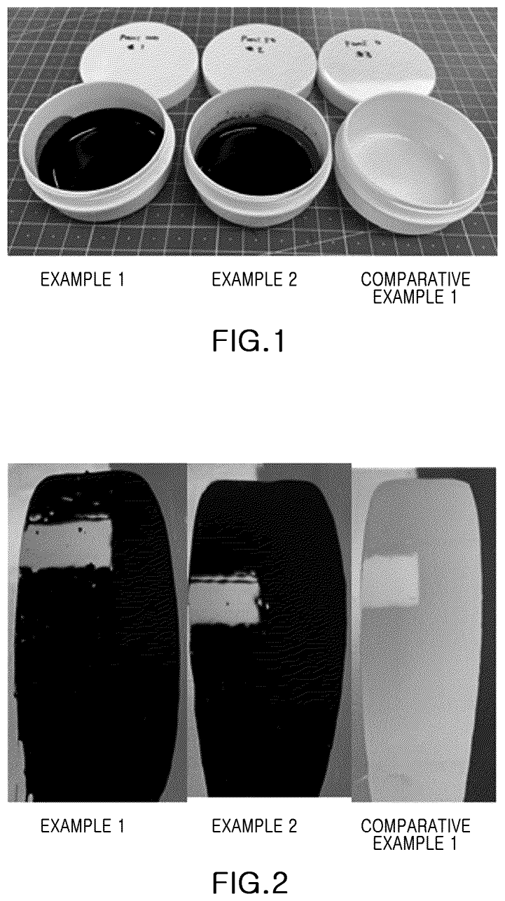

A slurry for an oxide-based solid electrolyte was manufactured by adding 8 wt % of polyaniline (PANi) which is a conductive polymer as a binder, 52 wt % of N-Methyl-2-pyrrolidone (NMP) as a solvent, 4 wt % of KD-6 as a dispersant, 4 wt % of dibutyl phthalate (DBP) as a plasticizer, and 32 wt % of LLZO as oxide particles, and stirring a mixture thereof. The manufactured slurry for an oxide-based solid electrolyte was captured, and a photograph thereof is shown in FIG. 1.

The slurry for an oxide-based solid electrolyte was cast onto a copper foil having a thickness of 20 μm at a loading weight (LW) of 2,000 mg/cm². The cast slurry for an oxide-based solid electrolyte was captured, and a photograph thereof is shown in FIG. 2.

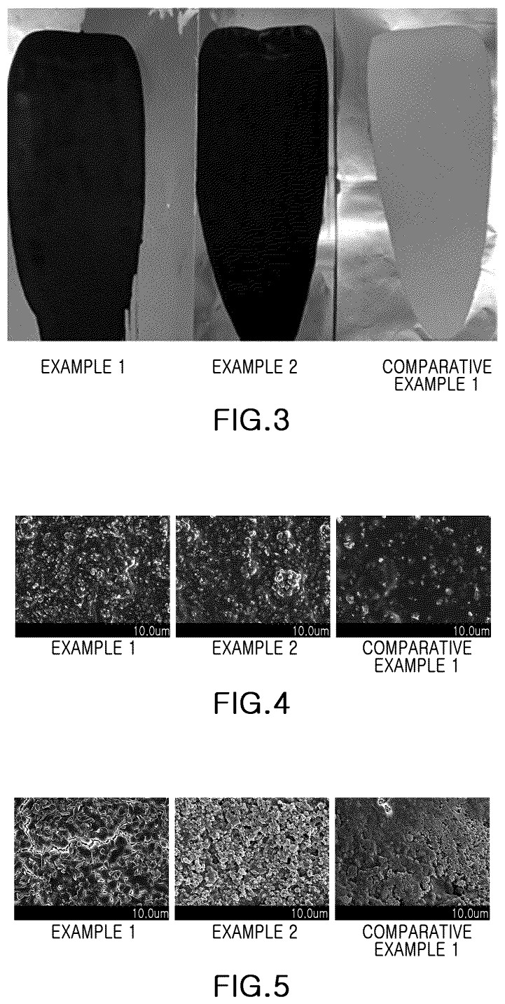

After casting the slurry for an oxide-based solid electrolyte, the slurry was dried in a 60° C. convection oven for 3 hours to manufacture an oxide-based thin film sheet having a thickness of about 100 μm. The manufactured oxide-based thin film sheet was captured, and a photograph thereof is shown in FIG. 3.

The oxide-based thin film sheet was cut to a size of 3 cm×3 cm and loaded into a photo-sintering device. An Invent product from Pulse Forge was used as the photo-sintering device. The oxide-based thin film sheet was then photo-sintered according to the photo-sintering conditions shown in Table 1, and an oxide-based solid electrolyte sheet having a thickness of about 80 μm was manufactured.

TABLE 1
Photo-sintering condition

| Condition forming one | Voltage | 400 | V |
|---|---|---|---|
| pulse | Light irradiation time | 4000 | μs |
| | per pulse (On-time) | | |
| | Number of pulses | 5 | times |
| Operating Condition | Temperature-increasing | 10 | Hz |
| | frequency (Fire rate) | | |
| | Number of pulse repetitions | 50 | |
| | Photo-sintering operation | 5 | s |
| | time | | |

The microstructure of the oxide-based solid electrolyte sheet was observed using an S-4800 scanning electron microscope from Hitachi.

The sheet resistance of the oxide-based solid electrolyte sheet was measured using a Loresta-GX MCP-T700 from Nittoseiko Analytech.

The colorimetric values of the oxide-based solid electrolyte sheet were measured using a TES-3250 from TES Electrical Electronic Corp. The colorimetric value represents brightness, and when the colorimetric value is 0, the color represents perfect black, and when the colorimetric value is 100 the color represents perfect white.

The ionic conductivity of the oxide-based solid electrolyte sheet was measured by electrochemical impedance analysis using a potentiostat (VMP-300) in an air atmosphere at room temperature (25° C.), and the impedance resistance values of examples and comparative examples were measured, and the ionic conductivity was calculated using Equation 2 below.

$$σ = D / ( R \times S ) \qquad [ Equation 2 ]$$

In Equation 2, σ represents the ionic conductivity (S/cm), D represents the thickness (cm) of the oxide-based solid electrolyte sheet, R represents the measured impedance resistance (1/S), and S represents the area (cm²) of the oxide-based solid electrolyte sheet.

A weight of the residual binder after photo-sintering relative to the total weight of the oxide-based solid electrolyte sheet was measured using a thermogravimetric analyzer (Discovery Q500) from TA instruments.

### Example 2

A slurry for an oxide-based solid electrolyte was manufactured using the same method as in Example 1, except that a mixture of 4 wt % of polyaniline (PANi) and 4 wt % of polyvinylbutyral (PVB, weight-average molecular weight 66,000 g/mol, glass transition temperature 67° C.) was used as the binder, and an oxide-based solid electrolyte sheet was manufactured using the same method as in Example 1.

### Comparative Example 1

A slurry for an oxide-based solid electrolyte was manufactured using the same method as in Example 1, except that 8 wt % of polyvinylbutyral (PVB) was used as the binder, and an oxide-based solid electrolyte sheet was manufactured using the same method as in Example 1.

In this case, an image of the oxide-based solid electrolyte slurry, an image in which the oxide-based solid electrolyte slurry is cast, and an image of the oxide-based thin film sheet were captured, respectively, and the photographs thereof are shown in FIGS. 1 to 3, respectively. FIGS. 4 and 5 show a microstructure of oxide-based thin film sheets before and after photo-sintering.

As illustrated in FIGS. 1, 2 and 3, it may be confirmed that the slurry and the oxide-based thin film sheet of Example 1, which include polyaniline as a conductive polymer, are darker in color, while the slurry and the oxide-based thin film sheet of Comparative Example 1, which include polyvinylidene butyral as a non-conductive binder, are lighter in color.

In FIG. 4, it may be confirmed that the microstructures of Examples 1 and 2 and the Comparative Example before photo-sintering appear similar. Upon observing the microstructure of the oxide-based thin film sheet after photo-sintering, illustrated in FIG. 5, it may be confirmed that as compared to Examples 1 and 2, photo-sintering was insufficient in the Comparative Example, thus observing residual binders in the microstructure.

Furthermore, the sheet resistance and colorimetric values of the oxide-based thin film sheet manufactured above were analyzed, and the ionic conductivity and the content of residual binders of the oxide-based solid electrolyte sheet were analyzed, and the results are shown in Table 2.

TABLE 2

| | Sheet | | Ionic | Content of |
|---|---|---|---|---|
| | resistance | Colorimetric | conductivity | residual binders |
| | (Ω/sq) | value | (S/cm) | (wt %) |
| Example 1 | 17.6 | 1.35 | 1.3 × 10⁻⁵ | 12 |
| Example 2 | 21.3 | 1.43 | 1.1 × 10⁻⁵ | 12 |
| Comparative | Over load | 20.5 | 2.5 × 10⁻⁷ | 14 |
| Example 1 | | | | |

As may be seen from Table 2 above, the sheet resistance of Example 1 was 17.6 Ω/sq, the sheet resistance of Example 2 was 21.3 Ω/sq, and the sheet resistance of Comparative Example 1 was not able to be measured because a value thereof exceeds the measurement range. From these results, it may be confirmed that, when a conductive polymer was used as a binder, sheet resistance was reduced.

As the amount of the colored conductive polymer added increases, the chromaticity values of the oxide-based solid electrolyte sheets decreased, which resulted in a darker color, and the chromaticity value of Example 1 was 1.35, the chromaticity value of Example 2 was 1.43, and the chromaticity value of Comparative Example 1 was 20.5. As in Examples 1 and 2, when the chromaticity values are low, the colored properties of the conductive polymer may be utilized to enhance light absorption, thereby improving photo-sintering efficiency.

The ionic conductivity of Example 1 was 1.3×10⁻⁵ S/cm, the ionic conductivity of Example 2 was 1.1×10⁻⁵ S/cm, and the ionic conductivity of Comparative Example 1 was 2.5×10⁻⁷ S/cm. In the case of an oxide-based solid electrolyte sheet formed by photo-sintering a slurry for an oxide-based solid electrolyte including a conductive polymer, it was confirmed that the ionic conductivity increased.

The content of a residual binder after photo-sintering as compared to the content of a binder before photo-sintering within the oxide-based solid electrolyte sheets of Examples 1 and 2 and Comparative Example 1 was measured using a thermogravimetric analyzer (TGA). The residual binder in the oxide-based solid electrolyte sheets corresponds to impurities within the sheets, and thus, when the content of the residual binder is high, the battery performance deteriorates. The content of the residual binder of Examples 1 and 2 was 12%, and the content of the residual binder of Comparative Example 1 was also 14%. When a conductive polymer was used as a binder, it was confirmed that there was no residual binder problem during the photo-sintering process as compared to a non-conductive binder.

While the embodiments of the present disclosure have been described in detail above, the scope of the present disclosure is not limited thereto, and it will be apparent to those skilled in the art that various modifications and variations are possible without departing from the technical spirit of the present disclosure as set forth in the claims.

What is claimed is:

1. A slurry for an oxide-based solid electrolyte comprising a conductive polymer and oxide particles.

2. The slurry for an oxide-based solid electrolyte of claim 1, wherein the conductive polymer includes a n-conjugated polymer structure.

3. The slurry for an oxide-based solid electrolyte of claim 2, wherein the conductive polymer including a n-conjugated polymer structure is one of polyacetylene (PA) and poly(p-phenylene vinylene) (PPV), or a mixture thereof.

4. The slurry for an oxide-based solid electrolyte of claim 2, wherein the conductive polymer further includes a heteroatom in a polymer main chain.

5. The slurry for an oxide-based solid electrolyte of claim 4, wherein the conductive polymer further including a heteroatom in the polymer main chain is one of polypyrrole (PPy), polythiophene (PT), poly(3,4-ethylenedioxythiophene (PEDOT)), poly(p-phenylene vinylene) (PPV) and polyaniline (PANi), or a mixture thereof.

6. The slurry for an oxide-based solid electrolyte of claim 2, wherein the conductive polymer further includes a doped heteroatom.

7. The slurry for an oxide-based solid electrolyte of claim 1, wherein the conductive polymer has a weight average molecular weight of 5,000 to 200,000 g/mol.

8. The slurry for an oxide-based solid electrolyte of claim 1, wherein the conductive polymer has a particle size of 3 to 100 μm.

9. The slurry for an oxide-based solid electrolyte of claim 1, wherein the conductive polymer has an electrical conductivity of 1 S/cm or more.

10. The slurry for an oxide-based solid electrolyte of claim 1, wherein the slurry further comprises a non-conductive binder.

11. The slurry for an oxide-based solid electrolyte of claim 1, wherein the conductive polymer includes a binding block.

12. The slurry for an oxide-based solid electrolyte of claim 11, wherein the binding block is a chain-like alkyl ether having 1 to 5 carbon atoms or an alkyl ester having 1 to 8 carbon atoms.

13. The slurry for an oxide-based solid electrolyte of claim 12, wherein the conductive polymer including the alkyl ether binding block having 1 to 5 carbon atoms is at least one selected from the group consisting of poly(ethylene oxide), poly(propylene oxide) and polytetrahydrofuran.

14. The slurry for an oxide-based solid electrolyte of claim 12, wherein the conductive polymer including the alkyl ester binding block having 1 to 8 carbon atoms is at least one selected from the group consisting of polycaprolactone, polylactide, polybutylene adipate and poly(methyl methacrylate).

15. The slurry for an oxide-based solid electrolyte of claim 11, wherein the conductive polymer including the binding block is at least one selected from the group consisting of PEDOT-block-PEG and polypyrrole-block-poly(caprolactone).

16. The slurry for an oxide-based solid electrolyte of claim 1, wherein the conductive polymer is included in an amount of 3 to 15 wt % based on a total weight of the slurry for an oxide-based solid electrolyte.

17. An oxide-based thin film sheet comprising a substrate and an oxide-based thin film layer formed of the slurry for an oxide-based solid electrolyte of claim 1 on the substrate.

18. The oxide-based thin film sheet of claim 17, wherein the oxide-based thin film sheet has a sheet resistance of 100 MΩ/sq or less.

19. The oxide-based thin film sheet of claim 18, wherein the oxide-based thin film sheet has a colorimetric value of 60 or less.

20. The oxide-based thin film sheet of claim 17, wherein the conductive polymer is included in an amount of 5 to 50 wt % based on a total weight of a solid content.
